(19) United States
(12) Patent Application Publication
(10) Pub. No.: US 2005/0146471 A1
(43) Pub. Date: Jul. 7, 2005

(54) Ultra-wideband antenna having an isotropic radiation pattern

(75) Inventors: Do-hoon Kwon, Seoul (KR); Seong-soo Lee, Suwon-si (KR)

Correspondence Address: Eugene M. Lee;LEE & STERBA, P.C., Suite 2000, 1101 Wilson Boulevard, Arlington, VA, 22209, US

(73) Assignee: Samsung Electronics Co., Ltd.

(21) Appl. No.: 11/006,703

(22) Filed: Dec. 8, 2004

(30) Foreign Application Priority Data
Dec. 8, 2003 (KR) 10-2003-0088777

(51) Int. Cl. H01Q 1/00

(52) U.S. Cl. 343/702; 343/700 R

(57) ABSTRACT

An ultra-wideband antenna having an isotropic radiation pattern includes a support plate, a feed line on the support plate, a radiating element connected to the feed line to transmit and receive signals, and a ground plate spaced apart from the feed line and attached to the support plate. The radiating element has at least two intersecting conductive plates.

### BACKGROUND OF THE INVENTION

1. Field of the Invention

The present invention relates to an antenna. More particularly, the present invention relates to an ultra-wideband (UWB) antenna having an isotropic radiation pattern.

2. Description of the Related Art

Recent commercial deployment of UWB systems, which make use of a 3.1 GHz to 10.6 GHz frequency band, has increased interest in UWB antennas that can provide effective radiation patterns. UWB antennas may be designed using printed circuit board (PCB) technology. Therefore, UWB antennas can be manufactured at low cost.

A UWB antenna interconverts electrical pulse signals and radio wave pulse signals. If radiating characteristics of the UWB antenna are directionally dependent, and the UWB communication system is not at a fixed location, e.g., mounted on a mobile terminal, communication quality is directionally dependent. Accordingly, it is desirable that UWB antennas emit pulse signals in all directions with equal strength and receive pulse signals from all directions without any distortion. Specifically, it is desirable that UWB antennas emit isotropic radiation patterns at a high frequency band as well as at a low frequency band.

FIGS. 1 through 3 are exemplary views of conventional planar UWB antennas.

A conventional UWB antenna 2 of FIG. 1 has a frequency bandwidth of about 50%. The UWB antenna 2 in FIG. 1A includes a inverted triangular radiating element 10 having a top portion 16 and a bottom portion 18, a transmission line 12 having a central conductor 12a, and a rectangular ground plane 14. The inverted triangular radiating element 10 includes a transition region 20 which connects the top portion 16 with the bottom portion 18, where the bottom portion 18 is narrower than the top portion 16. Power is fed to the radiating element 10 by a co-planar waveguide structure formed by the transmission line 12 and the rectangular ground plane 14.

Another conventional UWB antenna 1300 of FIG. 2 is a planar UWB antenna having first and second elliptical radiating elements 1304, 1306. The UWB antenna also includes a substrate 1302, a signal supply source 1308, a sector pin 1310, ground pins 1312, 1313, first and second connection loci 1315, 1317, and a feed structure 1320. The second elliptical radiating element 1306 includes first and second portions 1306a, 1306b. The feed structure 1320 includes intervals 1322, 1324 between the feed structure 1320 and the respective portions 1306a and 1306b of the second elliptical radiating element 1306.

If radiation patterns (not shown) of the conventional UWB antennas shown in FIGS. 1 and 2 are observed as a function of frequency in the horizontal plane, i.e., the X-Y plane of FIG. 1, both of the UWB antennas shown in FIGS. 1 and 2 provide an isotropic radiation pattern when operating at a low frequency. As the frequency increases, however, radiation for both of the UWB antennas is concentrated in the ±Y-direction of FIG. 1, i.e., a direction in which the antenna is positioned.

Yet another conventional UWB planar antenna of FIG. 3 includes an insulating substrate 400 serving as a support plane supporting first and second radiating elements 401, 402. A feed line 403 feeds power to the first radiating element 401. In the UWB antenna of FIG. 3, radiation is generated mainly due to a current flowing through the first and second radiating elements 401, 402 in the ±Z-direction. For the purpose of obtaining wideband frequency characteristics, widths in the Y-direction of the first and second radiating elements 401, 402 are similar to heights of the first and second radiating elements 401, 402. This allows current flowing in the ±Z-direction to be widely distributed in the ± the Y-direction. The widths of the first and second radiating elements 401, 402 are very narrow compared with wavelengths of a low frequency band within the UWB. Therefore, radio wave radiation due to the current flowing through the first and second radiating elements 401, 402 gives rise to constructive interference in the ±Y-direction as well as in the ±X-direction, resulting in isotropic radiation patterns in the horizontal plane, i.e., the X-Y plane.

However, the radiation patterns are changed if the frequency increases to a point at which the widths of the first and second radiating elements 401, 402 become comparable with the wavelength of the frequency. In other words, radio waves emitted by the current distributed in the Y-direction results in constructive interference in ±X-direction as for the low frequencies, but when the emitted radio wave approaches ±Y-axis, it results in destructive interference. As a result, the strength of the radio wave emitted by the current distributed in the Y-direction at positions adjacent to the ±Y-axis may be less than that in the ±X-direction.

Thus, as the frequency increases, the planar antenna of FIG. 3 may lose its isotropic radiation characteristics due to the current, which is widely distributed in the Y-direction.

As described above, the conventional UWB antennas have problems in that, as the frequency increases, the radiation is concentrated in a specific direction, i.e., the radiation patterns are seriously distorted. These problems with the conventional UWB antennas make it difficult to use UWB communication systems in mobile terminals.

### SUMMARY OF THE INVENTION

The present invention is therefore directed to a UWB antenna, which substantially overcomes one or more of the problems due to the limitations and disadvantages of the related art.

It is a feature of an embodiment of the present invention to provide a UWB antenna that provides an isotropic radiation pattern.

It is another feature of an embodiment of the present invention to provide a UWB antenna that provides an isotropic radiation pattern over the entire UWB.

At least one of the above and other features and advantages of the present invention may be realized by providing an ultra-wide band antenna, which includes a support plate, a feed line on the support plate, a radiating element connected to the feed line, the radiating element for transmitting and receiving signals, the radiating element including at least two intersecting conductive plates, and a ground plate spaced apart from the feed line and attached to the support plate.

The support plate may be a printed circuit board (PCB) or an epoxy substrate. The feed line and the ground plate may constitute a co-planar waveguide (CPW) structure. The feed line may be inserted into a groove formed on the support plate. The feed line may be installed on a front face of the support plate and the ground plate may be coated on a rear face of the support plate.

The at least two conductive plates may intersect vertically or obliquely, may have a same shape, or may have different shapes. At least one of the two conductive plates may be rotatable. A position of one of the at least two conductive plates may be matched with a position of the ground plate.

It is a feature of an embodiment of the UWB antenna of the present invention to obtain stable isotropic radiation patterns in the horizontal plane in the range from a low frequency band to a high frequency band in the UWB frequencies. Accordingly, UWB communication systems employing the UWB antenna of an embodiment of the present invention can be used in mobile terminals without problems, and excellent communication quality can be obtained regardless of a position of the mobile terminal.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a perspective view of a conventional planar UWB antenna;

FIG. 2 illustrates a plan view of another conventional planar UWB antenna;

FIG. 3 illustrates a perspective view of a yet another conventional planar UWB antenna;

FIG. 4A illustrates a perspective view of a UWB antenna according to an embodiment of the present invention;

FIG. 4B illustrates a perspective view of a UWB antenna including a modification of the first radiating element of the present invention;

FIG. 5A illustrates a perspective view of a first modification of the second radiating element which may be used with the UWB antenna of FIGS. 4A or 4B;

FIG. 5B illustrates a perspective view of a second modification of the second radiating element which may be used with the UWB antenna of FIGS. 4A or 4B;

FIG. 6 illustrates a plan view of the first radiating element of FIGS. 4A and 4B, and a modification in an arrangement thereof; and

FIGS. 7 through 10 illustrate plan views of radiation patterns at four frequencies for both the conventional antenna of FIG. 3 and the antenna of the present invention of FIG. 4A.

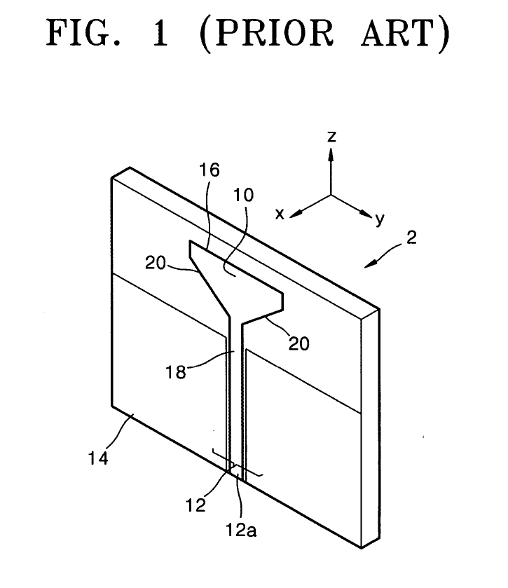

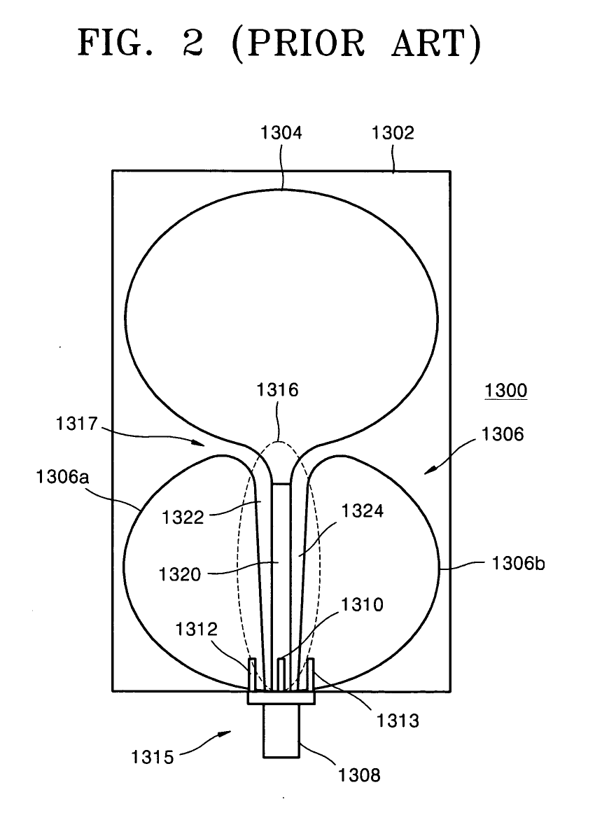

### DETAILED DESCRIPTION OF THE INVENTION

Korean Patent Application No. 2003-88777, filed on Dec. 8, 2003, in the Korean Intellectual Property Office, and entitled: “Ultra-wide Band Antenna Having Isotropic Radiation Pattern,” is incorporated by reference herein in its entirety.

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thickness of layers and regions are exaggerated for clarity. Like reference numerals in the drawings denote like elements, and thus their description will not be repeated.

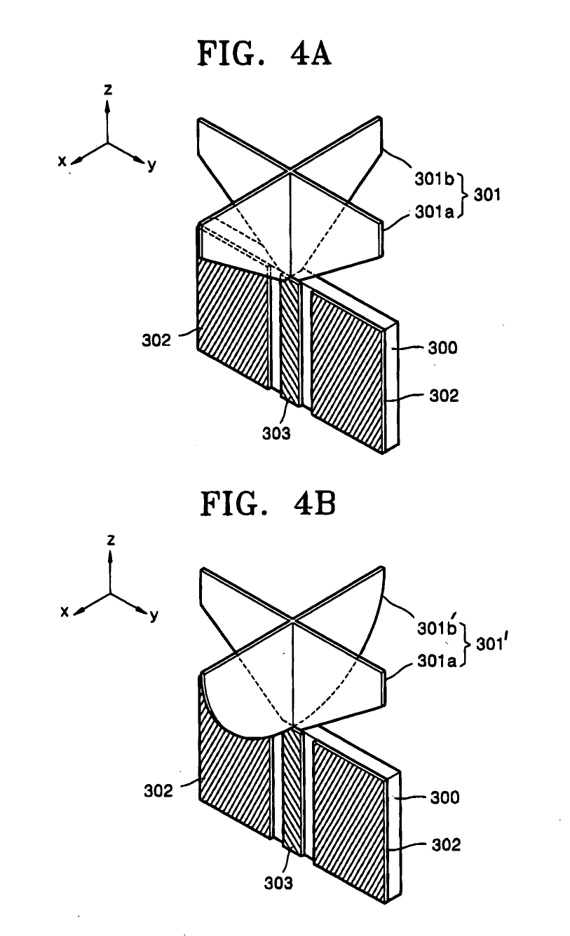

In FIGS. 4A and 4B, a UWB antenna having an isotropic radiation pattern according to the present invention, and a variation in the shape of a first radiating element, is shown and will be collectively referred to as “the antenna of the present invention.”

Referring to FIG. 4A, the antenna of the present invention includes a first radiating element 301, a second radiating element 302 and a feed line 303 that feeds power to the first radiating element 301. The first radiating element 301 is connected to an upper end portion of the feed line 303, and includes intersecting first and second conductive plates 301a and 301b. The second radiating element 302 may be a conductive ground plate.

The second radiating element 302 may be divided into two sections and attached to a surface of a support plate 300. The feed line 303 may be attached to the support plate 300 and disposed between the two sections of the second radiating element 302, in parallel with the second radiating element 302. Thus, the feed line 303 is provided on the same face of the support plate 300 as the second radiating element 302. As a result, the antenna of the present invention has a co-planar waveguide (CPW) feeding structure. The support plate 300 may be an insulating substrate, e.g., a printed circuit board (PCB) or an FR-4 epoxy substrate.

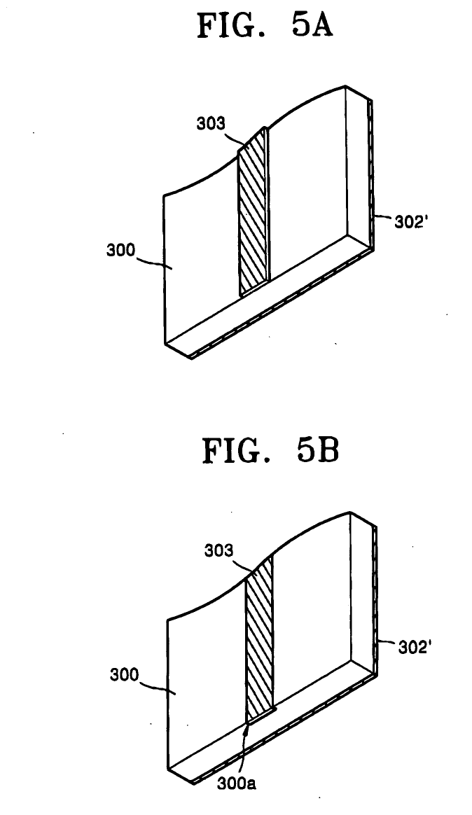

Alternatively, the feed line 303 and the second radiating element 302 may be provided on different faces from each other. For example, as shown in FIG. 5A, the feed line 303 may be provided as a microstrip on a first face of the support plate 300 and the second radiating element 302′ may be on a second face of the support plate 300, which is opposite to the first face. In this case, because the feed line 303 and the second radiating element 302′ are provided on different faces of the support plate 300, the second radiating element 302′ need not be divided into two sections in order to accommodate the feed line 303. In other words, the second radiating element 302′ can be provided over the entire second face of the support plate 300. Meanwhile, as shown in FIG. 5B, the feed line 303 may be inserted into a groove 300a formed in the support plate 300.

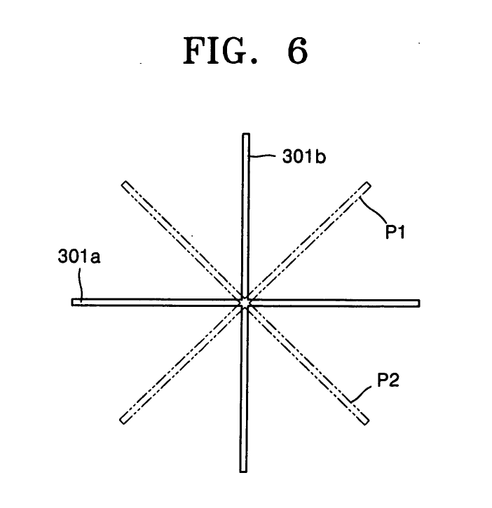

Returning to FIG. 4A, the first and second conductive plates 301a and 301b may be assembled as individual objects or may be formed as one body. The first and second conductive plates 301a, 301b may be any appropriate conductive material, e.g., copper (Cu) plates or aluminium (Al) plates. The first and second conductive plates 301a, 301b may intersect vertically, but are not required to intersect vertically. For example, as shown in FIG. 6, the second conductive plate 301b may be provided at a first position P1 or a second position P2, both of which are oblique to the first conductive plate 301a.

The first and second conductive plates 301a, 301b may have, but are not required to have, the same shape. For example, in FIG. 4B, a first radiating element 301′ differs from the first radiating element 301 by having conductive plates of different shapes. In the particular example shown in FIG. 4B, a second conductive plate 301b′ has a semicircular plate. As a further alternative, both the first and second conductive plates 301a, 301b may be semicircular.

In addition, as shown in FIG. 4A, upper surfaces of the first and second conductive plates 301a, 301b may be, but are not required to be, planar. For example, at least one upper line of the first and second conductive plates 301a, 301b may be convex or concave.

One of the first and second conductive plates 301a, 301b may be, but does not have to be, matched with the second radiating element 302. For example, the first and second conductive plates 301a and 301b may be disposed at the position indicated by the solid line in FIG. 6, in which the position of the first conductive plate 301a is matched with that of the second radiating element 302, or may be respectively disposed at the first and second positions P1 and P2 indicated by the dotted line.

As described above, because the first radiating element 301 is provided with a three-dimensional configuration, the current flowing through the antenna of the present invention in the Z-direction is distributed in the X-direction as well as in the Y-direction. Thus, the radio wave emission in the ±X-direction at high frequencies occurs due to the current flowing through the first conductive plate 301a, which exists in the Y-direction along the first radiating element 301. The radio wave emission in the ±Y-direction occurs due to the current flowing through the second conductive plate 301b, which exists in the X-direction along the first radiating element 301.

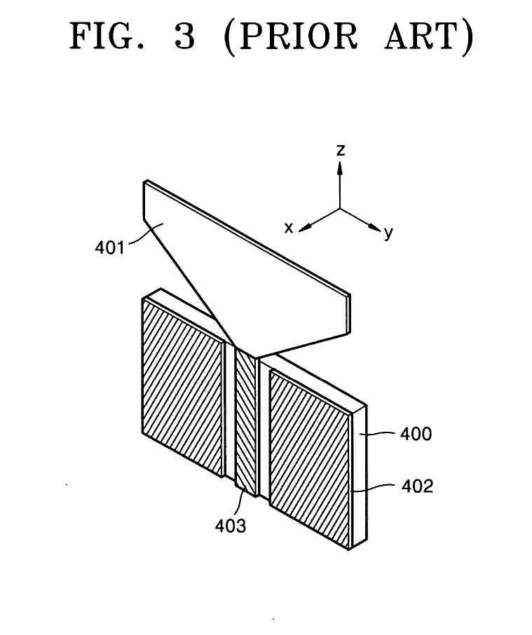

Accordingly, the antenna of the present invention can remarkably improve the undesirable phenomenon occurring in the conventional planar UWB antenna of FIG. 3, which loses its isotropic radiation characteristic because the radio wave emission weakens in the ±Y-direction while it strengthens in ±X-direction at high frequency bands. This means that the antenna of the present invention can maintain the isotropic radiation pattern in the horizontal plane, i.e., the X-Y plane, at high frequency bands as well as at low band frequency bands.

In order to verify the isotropic nature of the antenna of the present invention, simulation is carried out to compare the radiation characteristics of the conventional planar antenna (hereinafter, referred to as “the first antenna”) shown in FIG. 3 and the antenna of the present invention (hereinafter, referred to as “the second antenna”) shown in FIG. 4A.

For the purposes of the comparison, the respective support plates 400, 300 of each of the first and second antennas are a 1 mm thick FR-4 epoxy substrate and the respective second radiating elements 402, 302 of the first and second antennas are a 0.036 mm thick metal coating on the FR-4 epoxy substrate. In addition, the respective feed lines 403, 303 have 1.5 mm width arranged in a CPW feeding structure, and are 0.22 mm from the respective second radiating elements 402, 302.

In this simulation, four UWB frequencies, i.e., 3.1 GHz, 5.6 GHz, 8.1 GHz and 10.6 GHz, are sequentially radiated through the first and second antennas. Then, the radiation patterns at the respective frequencies are measured on the X-Y plane. Thereafter, a ratio of maximum gain to minimum gain in the respective radiation patterns (hereinafter, referred to as “the gain ratio”) is evaluated for determining how isotropic the radiation pattern is for each antenna. Here, the radiation patterns with respect to the frequencies are measured using an azimuth function and the X-direction is set as azimuth of 0°.

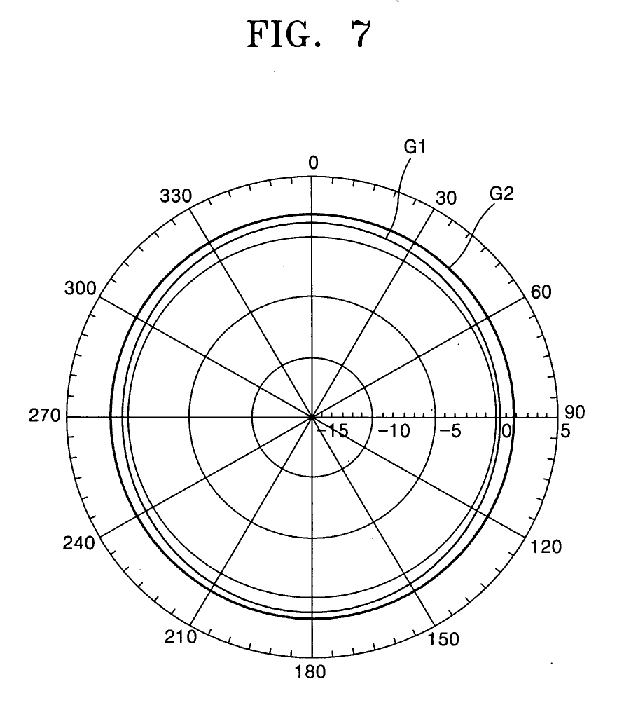

FIGS. 7 through 10 illustrate the radiation patterns measured in the simulation.

FIG. 7 illustrates a radiation pattern G1 of the first antenna (hereinafter referred to as “the first radiation pattern”) and a radiation pattern G2 of the second antenna (hereinafter, referred to as “the second radiation pattern”), which are measured when 3.1 GHz signals are radiated through the first and second antennas (hereinafter, referred to as “the first case”).

In the first case, it can be seen from the first and second radiation patterns G1 and G2 that gain ratios of the first and second antennas are 0.81 dB and 0.53 dB, respectively. Thus, both the first and second antennas have fairly isotropic radiation patterns at a low frequency in the UWB.

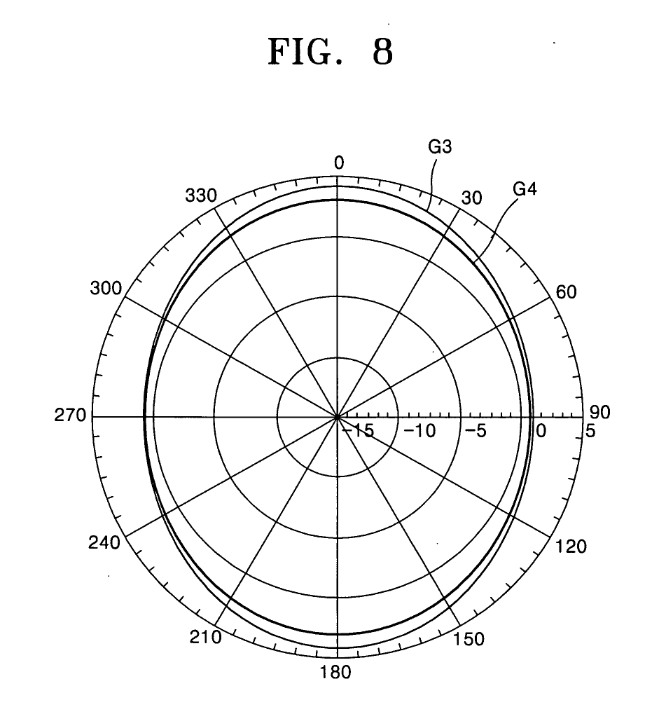

FIG. 8 illustrates a radiation pattern G3 of the first antenna (hereinafter, referred to as “the third radiation pattern”) and a radiation pattern G4 of the second antenna (hereinafter, referred to as “the fourth radiation pattern”), which are measured when 5.6 GHz signals are radiated through the first and second antennas (hereinafter, referred to as “the second case”).

In the second case, it can be seen from the third and fourth radiation patterns G3 and G4 that a gain ratio of the second antenna is 2.4 dB, while a gain ratio of the first antenna is 3.7 dB. Since a lower gain ratio corresponds to a superior isotropic characteristic of the antenna, it can be seen that the second antenna has a superior isotropic characteristic than the first antenna.

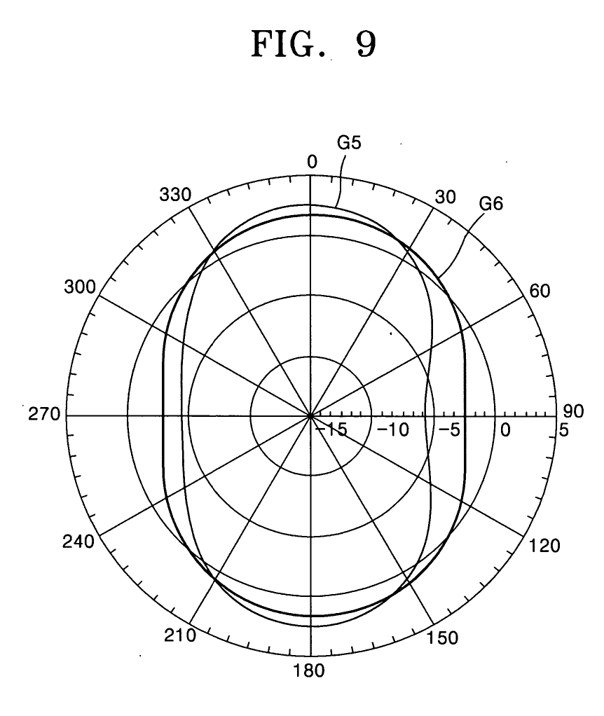

FIG. 9 illustrates a radiation pattern G5 of the first antenna (hereinafter, referred to as “the fifth radiation pattern”) and a radiation pattern G6 of the second antenna (hereinafter, referred to as “the sixth radiation pattern”), which are measured when 8.1 GHz signals are radiated through the first and second antennas (hereinafter, referred to as “the third case”).

In the third case, it can be seen from the fifth and sixth radiation patterns G5 and G6 that a gain ratio of the second antenna is 4.5 dB, while a gain ratio of the first antenna is 8.3 dB. In the third case, the radiation pattern of the second antenna also has an improved isotropic characteristic as compared to the first antenna.

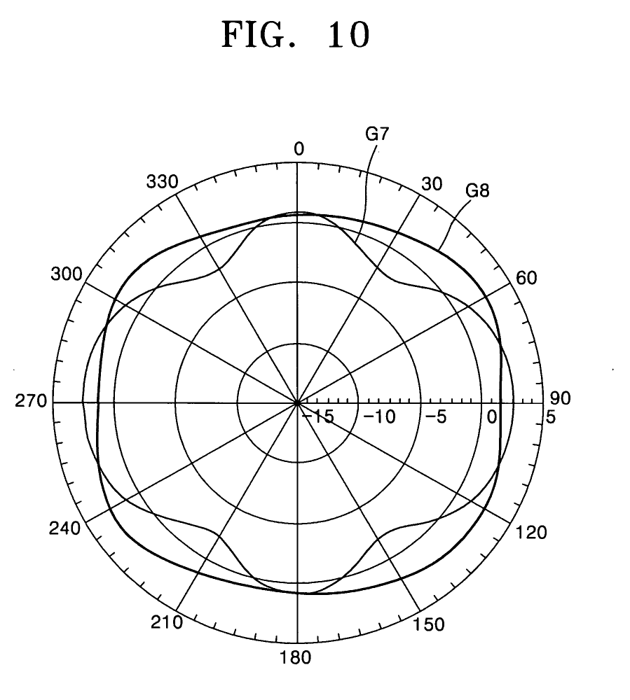

FIG. 10 illustrates a radiation pattern G7 of the first antenna (hereinafter, referred to as “the seventh radiation pattern”) and a radiation pattern G8 of the second antenna (hereinafter, referred to as “the eighth radiation pattern”), which are measured when 10.6 GHz signals are radiated through the first and second antennas (hereinafter, referred to as “the fourth case”).

In the fourth case, it can be seen from the seventh and eighth radiation patterns G7 and G8 that a gain ratio of the second antenna is 2.1 dB, while a gain ratio of the first antenna is 4.8 dB. Again, the second antenna has a better isotropic characteristic than the first antenna.

Through the above simulation, it is evident that the gain ratio of the second antenna is lower than that of the first antenna by minimum 1.3 dB and maximum 3.8 dB over the range of UWB frequencies. Thus, the antenna of the present invention shown in FIG. 4A has an improved isotropic radiation pattern, as compared to the conventional planar UWB antenna shown in FIG. 3. Similar results may be realized employing the variations in the antenna structure discussed above.

As described above, the UWB antenna of the present invention has a three-dimensional radiating structure that includes two intersecting conductive plates. Therefore, the UWB antenna of the present invention can obtain stable isotropic radiation patterns on the horizontal plane in the range from the low frequency band to the high frequency band in the UWB frequencies. Accordingly, UWB communication systems employing the UWB antenna of the present invention can be used in mobile terminals without problems, and excellent communication quality can be obtained regardless of a position of the mobile terminal.

Those skilled in the art can variously configure the first and second conductive plates 301a, 301b of the first radiating element 301. For example, the first conductive plate 301a may be fixed and the second conductive plate 301b may be rotatable. In this case, the second conductive plate 301b can be maintained vertical to the first conductive plate 301a, and the second conductive plate 301b can overlap the first conductive plate 301a. At this time, the second conductive plate 301b can be rotated manually or automatically. Alternatively, both plates may also be rotatable. In addition, a groove large enough to receive the feed line 303 may be formed at a predetermined position on the support plate 300, and then, the feed line 303 may be inserted therein. In order to further improve the isotropic characteristic, the first radiating element can be provided with three or more intersecting conductive plates. For example, four conductive plates may intersect in accordance with the alternative positions shown in FIG. 6.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1. An ultra-wideband antenna, comprising:
a support plate;
a feed line on the support plate;
a radiating element connected to the feed line, the radiating element for transmitting and receiving signals, the radiating element including at least two intersecting conductive plates; and
a ground plate spaced apart from the feed line and attached to the support plate.

2. The ultra-wideband antenna as claimed in claim 1, wherein the support plate is a printed circuit board (PCB) or an epoxy substrate.

3. The ultra-wideband antenna as claimed in claim 1, wherein the feed line and the ground plate constitute a co-planar waveguide (CPW) structure.

4. The ultra-wideband antenna as claimed in claim 3, wherein the feed line is inserted into a groove formed on the support plate.

5. The ultra-wideband antenna of claim 1, wherein the feed line is installed on a front face of the support plate and the ground plate is coated on a rear face of the support plate.

6. The ultra-wideband antenna as claimed in claim 1, wherein the at least two conductive plates intersect vertically.

7. The ultra-wideband antenna as claimed in claim 1, wherein the at least two conductive plates have a same shape.

8. The ultra-wideband antenna as claimed in claim 1, wherein the at least two conductive plates have different shapes.

9. The ultra-wide band antenna as claimed in claim 1, wherein at least one of the two conductive plates is rotatable.

10. The ultra-wideband antenna as claimed in claim 1, wherein the at least two conductive plates intersect obliquely.

11. The ultra-wideband antenna as claimed in claim 1, wherein a position of one of the at least two conductive plates is matched with a position of the ground plate.
